(19) United States
(12) Patent Application Publication
(10) Pub. No.: US 2013/0247036 A1
(43) Pub. Date: Sep. 19, 2013

(54) INFORMATION PROCESSING APPARATUS, VIRTUAL IMAGE FILE CREATION SYSTEM, AND VIRTUAL IMAGE FILE CREATION METHOD

(71) Applicant: Yuji Fujiwara, Hamura-shi (JP)

(72) Inventor: Yuji Fujiwara, Hamura-shi (JP)

(21) Appl. No.: 13/713,806

(22) Filed: Dec. 13, 2012

(30) Foreign Application Priority Data
Mar. 13, 2012 (JP) 2012-056484

(51) Int. Cl. G06F 9/455

(52) U.S. Cl. CPC G06F 9/455
USPC 718/1

(57) ABSTRACT

According to one embodiment, an information processing apparatus is configured to create a virtual image file executing a virtual machine by a virtualization client terminal. The apparatus includes a setting module. The setting module is configured to set, for the virtual image file, a domain name of a domain and a user ID and a password to participate in the domain, when the virtual image file is created.

### CROSS-REFERENCE TO RELATED APPLICATIONS

This application is based upon and claims the benefit of priority from Japanese Patent Application No. 2012-056484, filed Mar. 13, 2012, the entire contents of which are incorporated herein by reference.

### FIELD

Embodiments described herein relate generally to an information processing apparatus, a virtual image file creation system, and a virtual image file creation method, which create a virtual image file for executing a virtual machine by a client virtualization terminal.

### BACKGROUND

In recent years, in various companies, a virtual image file is distributed to a client virtualization terminal, a virtual machine is executed by using the client virtualization terminal, and the user uses an environment which is executed by the virtual machine. In addition, in many companies, a domain controller is installed to manage users.

In the prior art, after a virtual image file is distributed to a client virtualization terminal, domain participation is performed by the client virtualization terminal, and thus much time is required until the virtual machine can be used since the client virtualization terminal has downloaded the image file.

After a virtual image file is distributed to a client virtualization terminal, domain participation is performed by the client virtualization terminal, and thus much time is required until the virtual machine can be used since the client virtualization terminal has downloaded the image file.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram of a schematic configuration of a virtual image file creation system according to an embodiment.

FIG. 2 is an exemplary diagram for explaining a method of dealing with each disk (image file) in a fat client terminal.

FIG. 3 is an exemplary diagram for explaining a user profile which is managed by a connection broker.

FIG. 4 is an exemplary block diagram illustrating a configuration of a client management system according to the embodiment.

FIG. 5 is an exemplary block diagram illustrating a structure of a management server.

FIG. 6 is an exemplary diagram illustrating information which is stored in a client management database file.

FIG. 7 is an exemplary diagram illustrating information which is stored in a group management database file.

FIG. 8 is an exemplary diagram illustrating information which is stored in a virtual image file management database file.

FIG. 9 is an exemplary diagram illustrating types of image files.

FIG. 10 is an exemplary diagram illustrating items which are managed by a system management module.

FIG. 11 is an exemplary block diagram illustrating a structure of a virtual image file creation and distribution server.

FIG. 12 is an exemplary diagram illustrating a process of creating a virtual image file.

FIG. 13 is an exemplary block diagram illustrating a structure of the connection broker.

FIG. 14 is an exemplary diagram illustrating information which is stored in a user management database file.

FIG. 15 is an exemplary diagram illustrating a structure of a fat client terminal.

FIG. 16 is an exemplary diagram illustrating a structure of the fat client terminal.

FIG. 17 is an exemplary diagram illustrating a structure of the fat client terminal.

FIG. 18 is an exemplary flowchart illustrating a process performed to cause the fat client terminal to be usable.

FIG. 19 is an exemplary flowchart illustrating a process of the fat client terminal querying the management server about whether there is any new virtual image file or not.

FIG. 20 is an exemplary flowchart illustrating a process performed in logon.

FIG. 21 is an exemplary flowchart illustrating a process from creation of a master image file to creation of a reset image file.

FIG. 22 is an exemplary diagram illustrating an image file creation picture which is displayed by a web browser.

FIG. 23 is an exemplary diagram illustrating a new image file creation picture which is displayed by the web browser.

FIG. 24 is an exemplary diagram illustrating an image file creation picture which is displayed by the web browser.

FIG. 25 is an exemplary diagram illustrating a display picture which is displayed when a virtual image file is selected and a connection button is operated.

FIG. 26 is an exemplary diagram illustrating a display picture which is displayed when a power button in FIG. 25 is operated.

FIG. 27 is an exemplary diagram illustrating a display picture displayed when an operating system is installed.

FIG. 28 is an exemplary diagram illustrating a group edit picture displayed after the virtual image file is registered.

FIG. 29 is an exemplary flowchart illustrating a process of creating an individual image file.

FIG. 30 is an exemplary diagram illustrating parameters which are included in an individual image file creation request command.

FIG. 31 is an exemplary diagram illustrating an example of individual image file creation parameters.

FIG. 32 is an exemplary block diagram illustrating a structure of a client management system according to a modification.

FIG. 33 is an exemplary diagram illustrating a picture for registering an application which is to be executed before logon.

FIG. 34 is an exemplary diagram illustrating an application picture for applying to taking out the client terminal.

FIG. 35 is an exemplary flowchart illustrating a process of updating an image file when remote connection is performed from outside the company to inside the company.

### DETAILED DESCRIPTION

Various embodiments will be described hereinafter with reference to the accompanying drawings.

In general, according to one embodiment, an information processing apparatus is configured to create a virtual image file executing a virtual machine by a virtualization client terminal. The apparatus includes a setting module. The setting module is configured to set, for the virtual image file, a domain name of a domain and a user ID and a password to participate in the domain, when the virtual image file is created.

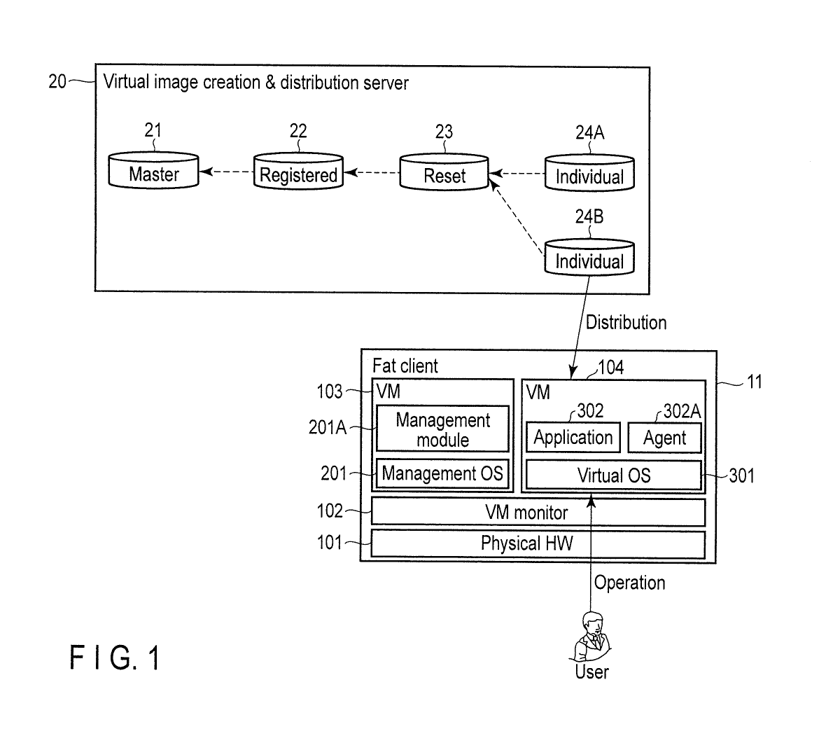

FIG. 1 illustrates a schematic system configuration of a client management system 1 which includes an information processing apparatus according to an embodiment.

As illustrated in FIG. 1, virtual image files 21, 22, 23, 24A, and 24B, which are created by a virtual image file creation and distribution server (information processing apparatus) 20 and configured to execute a virtual machine, are distributed to a client virtualization machine (hereinafter referred to as fat client terminal) 11. The user operates a virtual machine 104 of the client virtualization terminal, like an ordinary personal computer.

The virtual image file creation and distribution server 20 creates a master image file 21, a registered image file 22, a reset image file 23, and individual image files 24A and 24B, as virtual image files. The image files which are distributed to the fat client terminal 11 are individual image files 21, 22, 23, and 24B. The master image file 21, the registering image file 22, the reset image file 23, and the individual image files 24 will be explained later.

In the client terminal 11, a virtual machine monitor 102 is executed on physical hardware 101 such as a CPU, a memory, a storage, and various I/O devices. The virtual machine monitor 102 is virtualization software such as a hypervisor, and functions as a virtualization layer on the physical hardware 101 by emulating a resource of the physical hardware 101. Some virtual machines are executed on the virtual machine monitor 102 which is the virtualization layer. In FIG. 1, it is supposed that two virtual machines 103 and 104 are executed on the virtual machine monitor 102. The virtual machine 103 is a virtual machine for executing a management OS (host OS) 201. On the other hand, the virtual machine 104 executes a virtual OS (guest OS) 301 and an application program 302 in the virtual image file which is distributed from the system 1. The virtual machine 104, that is, the virtual OS (guest OS) 301 and the application program 302 operate as a desktop environment of the fat client terminal 11.

The management OS (host OS) 201 can control the virtual machine 104, in cooperation with the virtual machine monitor 102. A virtual machine management module 201A operates on the management OS (host OS) 201. The virtual machine management module 201A can download virtual image files from the virtual image file creation and distribution server 20 in the client management system 1, or copy an installer from the virtual image file creation and distribution server 20 into a USB memory or the like and perform installation offline. An agent 302A operates on the virtual OS (guest OS) 301. The agent 302A is a program which performs processing of causing the system 1 to cooperate with the fat client terminal 11.

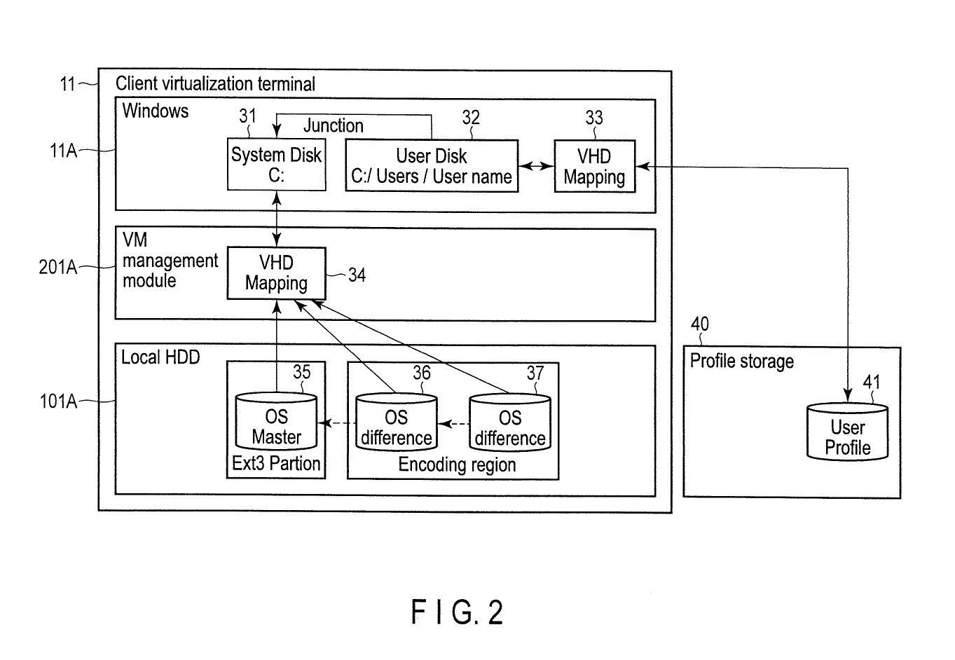

FIG. 2 is a diagram for explaining a method of dealing with each disk (image file) in the fat client terminal 11. A virtual disk 35 is a virtual image file which is created by the virtual image file creation and distribution server 20. Although the virtual disk 35 is illustrated as one virtual disk in FIG. 2, the virtual disk 35 may be formed of a plurality of difference disks. A virtual disk 36 is a difference disk which has the virtual disk 35 as parent disk. Image file update processing (installation and activation of the driver) in the fat client terminal 11 is stored in the virtual disk 36. When image file update processing is finished, writing in the virtual disk 36 becomes impossible. A virtual disk 37 is a difference disk which has the virtual disk 36 as a parent disk. The virtual disk 37 is deleted whenever the virtual machine is started. A user profile 41 is stored in a profile storage 40, and is not deleted even when the virtual disk 35 is re-distributed. The user profile 41 is created for each user. The user profile 41 is managed on the profile storage 40.

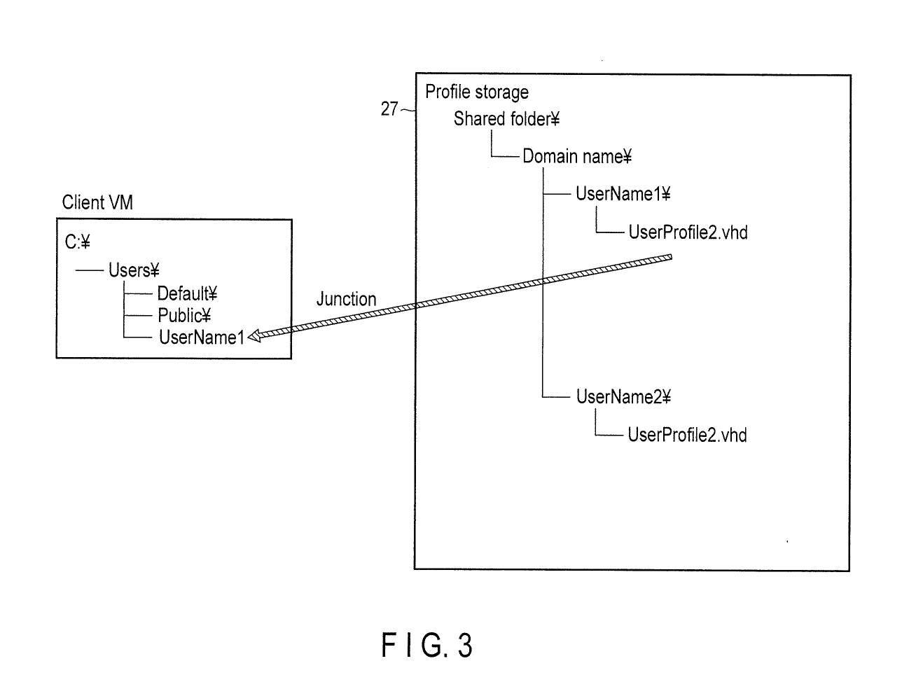

FIG. 3 is a diagram for explaining a method of managing the user profile. As illustrated in FIG. 3, a difference disk which stores the user profile in the profile storage 40 is used as the user profile “C:\Users\%UserName%”, by creating a junction point to access the difference disk that stores the user profile in the profile storage 40.

The “system disk C:” 31 is formed of the virtual disks 35, 36, and 37. Access to the “system disk C:” 31 from Windows (Registered trademark) 11A is performed by VHD mapping 34 in the virtual machine management module 201A by accessing one of the virtual disks 35, 36, and 37. When the user disk (C:\Users\%UserName%) 32 is accessed, VHD mapping 33 accesses the user profile 41 in the profile storage 40.

<System Configuration>

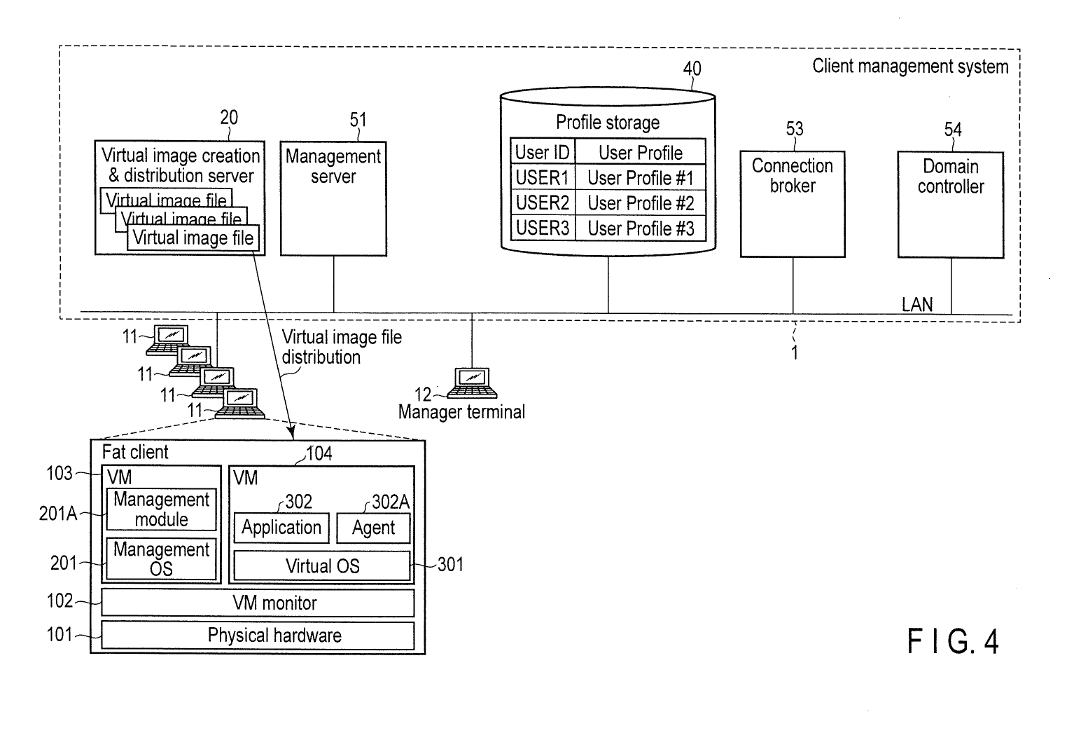

FIG. 4 is a diagram illustrating a whole configuration of a client management system 1 which includes an information processing apparatus according to an embodiment. The client management system 1 is a server system configured to manage a plurality of client terminals. The client management system 1 can be realized by one or a plurality of servers (physical servers). In this example, suppose that the client management system 1 is realized by a plurality of servers.

As illustrated in FIG. 4, the client management system 1 includes a management server 51, a connection broker 53, a domain controller 54, the virtual image file creation and distribution server 20, and the profile storage 40, and the like.

The management server 51, the connection broker 53, the domain controller 54, the virtual image file creation and distribution server 20, the connection broker 53, and the profile storage 40 are connected to a network, such as a LAN.

The client management system 1 is installed in, for example, an office. The client management system 1 is dedicated to managing a plurality of fat client terminals 11, which are arranged in the office, via the management server 51. In addition, in the client management system 1, a plurality of user profiles which are applied to the fat client terminals 11 are stored in the profile storage 40. Each user profile includes setting information for setting a user environment of the fat client terminal 11 to which the user profile is applied, such as various setting information relating to each application program, and various setting information relating to the desktop picture. Each user profile also includes user data, such as a document file which is created by the user by using an application program.

Next, components of the client management system 1 will be explained hereinafter.

<Management Server>

The management server 51 is a server configured to manage operation of the client management system 1. The management server 51 can perform management of each user who can use the client management system 1, and management of the virtual image files which correspond to the fat client terminals 11, in response to operation from a manager terminal 12 which is connected to the LAN.

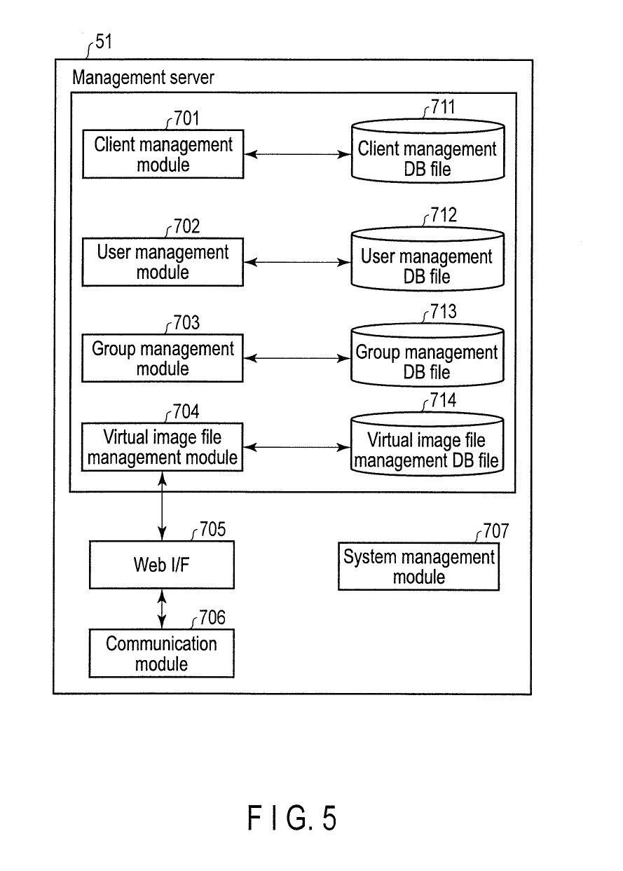

FIG. 5 is a block diagram illustrating a structure of the management server 51.

The management server 51 includes a client management module 701, a group management module 703, a virtual image file management module 704, a communication module 706, a web interface (web I/F) 705, and a system management module 707, and the like.

The client management module 701 manages the fat client terminal 11, by using a client management database file (client management DB file) 711.

FIG. 10 is a diagram illustrating an example of information managed by the system management module 707. As illustrated in FIG. 10, the system management module 707 manages information such as the name of the virtual image file creation and distribution server, the name of the connection broker, the name of the virtual machine management server, and domain information.

The name of the virtual image file creation and distribution server is a name for accessing the virtual image file creation and distribution server 20 by the management server 51. The name of the connection broker is a name for accessing the connection broker 53 by the management server 51. The domain information is information for participating in the domain by the virtual machine.

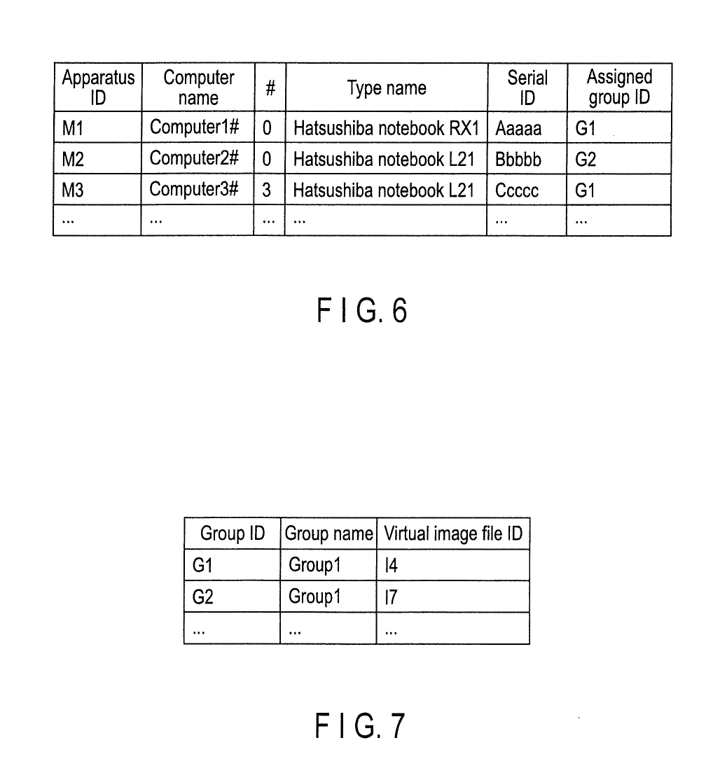

FIG. 6 is a diagram illustrating information which is stored in the client management DB file 711.

The client management DB file 711 includes items “apparatus ID”, “computer name”, “type name”, “serial ID”, “and assigned group ID”.

The item “apparatus ID” registers IDs which are assigned to respective apparatuses to distinguish apparatuses in the system and unique to the respective apparatuses.

The item “computer name” registers apparatus names which are assigned to the respective apparatuses. The “computer name” is used as a computer name of the virtual machine which is used in the fat client terminal 11. The naming rules of the apparatus name differ according to the type of the apparatus. In the case of the fat client terminal 11, the apparatus name is formed of the user designated part “ComputerN (N is an integer)” and the automatically-issued number part “#”. The automatically-issued number part “#” can have a value from “0” to “9”. The part “#” of the computer name of the virtual machine increases by 1 whenever a virtual machine is created, and changes like “0, 1, . . . , 9, 0, 1 . . . ”.

When a new image is created, the part “#” is increased, to prevent the virtual machine which is being used in the fat client terminal 11 at present from overlapping the computer name of the virtual machine created by the virtual image creation server. Since only two virtual machines exist simultaneously, the numbers “0” and “1” may be alternately used.

The item “Type name” registers actual apparatus names. For example, “Product Name” of DMI information is used. The “Product Name” of DMI information indicates “Product Name” (Offset 05h) of SMBIOS Specification System Information (Type 1).

The Serial ID is an ID to uniquely identify the apparatus. As examples of the serial ID, it is possible to use a MAC address of the network adaptor mounted to the apparatus, and Serial Number (Offset 07h) of SMBIOS Specification System Information (Type 1).

The item “Assigned group” registers IDs of the groups to which the fat client terminals 11 belong. Terminals or machines which belong to the same group can use the virtual image file of the same content, even when their types are different from each other.

The group management module 703 manages the group which is set in the system, by using a group management database file (group management DB file) 713.

FIG. 7 is a diagram illustrating information which is stored in the group management DB file 713. The group management DB file 713 is provided with items such as “group ID”, “group name”, and “virtual image file ID”.

The ID of the virtual image file which is used in the group is managed by using the group ID and the group name. A virtual image file which is changed to a “reset” state by the virtual image file creation and distribution server 20 can be designated.

The virtual image file management module 704 manages the virtual image file which is created by the virtual image file creation and distribution server 20, by using a virtual image file management database file (virtual image file management DB file) 714.

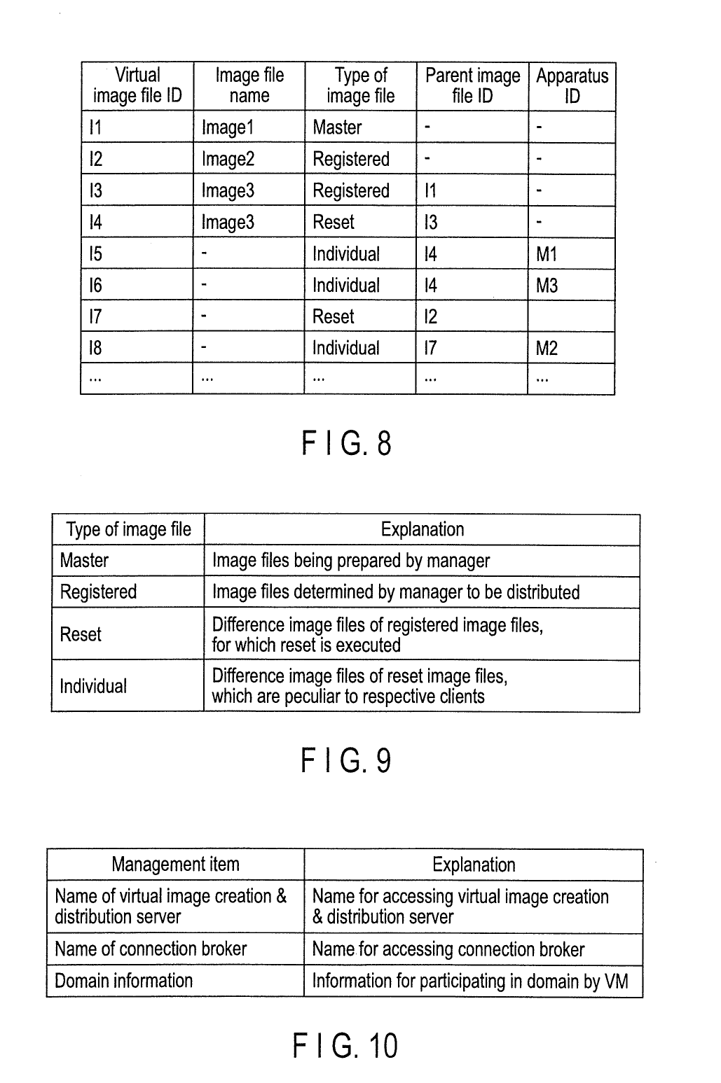

FIG. 8 is a diagram illustrating information which is stored in the virtual image file management DB file 714.

The virtual image file management DB file 714 is provided with items “virtual image file ID”, “image file name”, “type of image file”, “parent image file ID”, and “apparatus ID”.

The item “virtual image file ID” registers virtual image file IDs which are uniquely assigned by the management server 51.

The item “image file name” registers names which are set for the virtual image file IDs by the manager. The naming method of the “image file name” differs according to the type of the image.

The name of the image file, “type of image file” of which is “master” or “registered”, is set by the manager. When the “type of the image file” is “registered”, the name of the image file takes over the name of the parent image file, when no name is set for the image file by the manager. In addition, when the “type of the image file” is “reset”, the image file takes over the name of the “registered” image file.

The item “type of the image file” registers a value which indicates one of “master image file”, “reset image file”, “registered image file”, and “individual image file”.

FIG. 9 is a diagram illustrating an example of “type of image”.

The file “master image file” is a virtual image file which is being created by the manager. The file “master image file” is a virtual image file, for which the operating system or the application program is being installed, or user information is being registered. The file “registered image file” is a virtual image file which is determined by the manager to be distributed to the terminal. It is a virtual image file for which installation of the operating system and/or the application program has been finished.

The file “reset image file” is a difference image file of “registered image file”, and a virtual image file obtained by resetting the “registered image file”. The file “reset image file” is a virtual image file which is obtained by removing specific information, such as user information, from the “registered image file”. The operation system and the application program which are installed in the “registered” image file are left in the “reset image file”.

The file “individual image file” is a difference image file of the “reset image file”, and a virtual image file which is peculiar to each client.

<Virtual Image File Creation and Distribution Server>

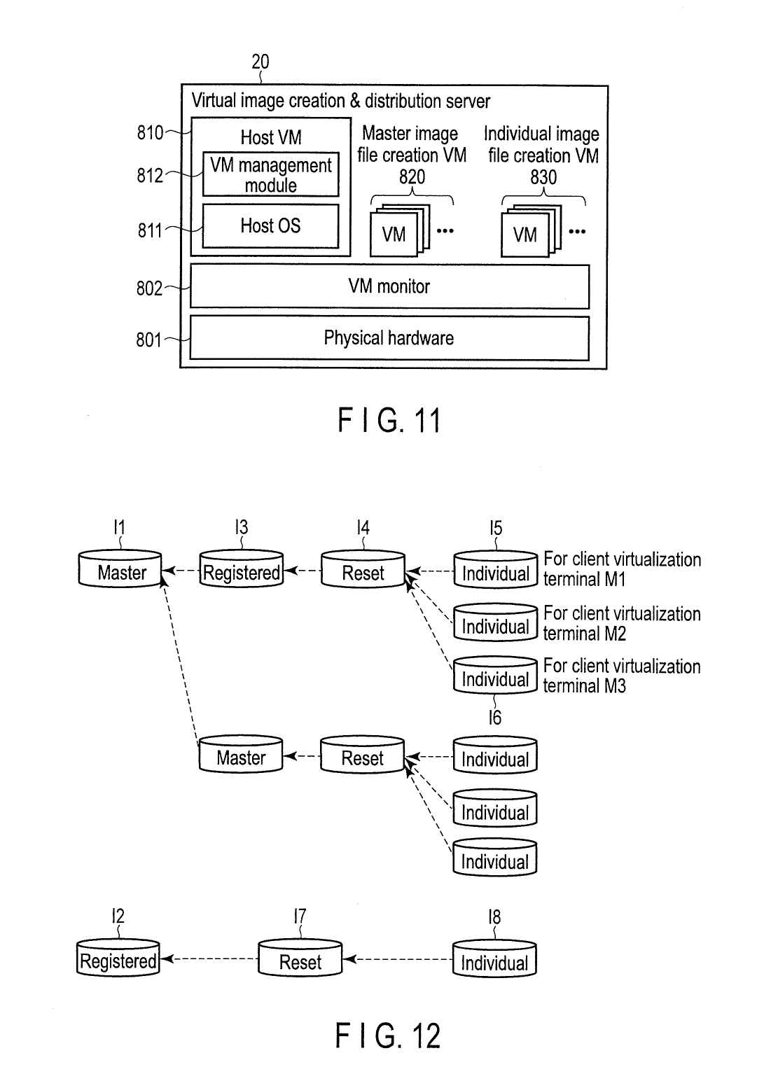

FIG. 11 is a diagram illustrating a structure of the virtual image file creation and distribution server 20.

The virtual image file creation and distribution server 20 creates two types of virtual machines, that is, master image file creation virtual machines 820 and individual image file creation virtual machines 830. The master image file creation virtual machines 820 deals with “master image file”, “registered image file”, and “reset image file”, among the types of image files illustrated in FIG. 9. The individual image file creation virtual machines 830 deal with “individual image file”. The number of the master image file creation virtual machines and the number of the individual image file creation virtual machines can be set by the manager through the management server 51.

It is not always required to create the same number of the virtual machines and the virtual image files. The virtual machines and the virtual image files are managed separately, and a vacant virtual machine is used when a virtual image file is executed. When the virtual machine is finished, the virtual image file is separated from the virtual machine. Specifically, the number of the virtual machines indicates the number of virtual machines which can be simultaneously executed.

Since the master image file creation virtual machine is actually operated by the manager, it is necessary to set a plurality of virtual machines when there are a plurality of managers or one manager operates a plurality of master image files simultaneously.

On the other hand, each individual image file creation virtual machine is used for creating a reset individual image file.

FIG. 12 is a diagram for explaining a method of creating a virtual image file by an individual image file creation virtual machine. As illustrated in FIG. 12, generally, a plurality of individual image files I5 and I6 are created from one master image file I1. In an example of actual use, one master image file is created in an organization, and all the members of the organization use the created master image file. Therefore, when there are twenty members, twenty individual image files are created for one master image file. Although the individual image files are automatically created, when there are a number of virtual machines, creation of the individual image files can be finished earlier, since the virtual machines create individual image files in parallel.

<Profile Storage>

The profile storage 40 stores a number of user profiles which are correlated with respective identifiers (user ID) of a number of users who can use the system 1. Specifically, the profile storage 40 includes a number of storage places for storing user profiles which correspond to respective users. Suppose that a user performs a logon operation to connect (logon) to the system 1 by using a fat client terminal 11. In this case, a user profile which is correlated with the user ID of the user is automatically mounted to the file system of the virtual machine that corresponds to the fat client terminal 11. For example, in the logon processing of the fat client terminal 11, the user profile which corresponds to the user who has performed the logon operation is mounted onto the file system of the virtual machine 104 in the fat client terminal 11. No actual user profile (setting information, user data) exists in the local storage in the fat client terminal 11, but the actual user profile is managed in the system 1. Therefore, it is possible to strengthen the security of the fat client terminal 11.

The profile storage 40 may be realized by a storage in a file server (not shown) in the system 1.

<Connection Broker>

The connection broker 53 is a device which is applied to the client management system 1, to manage the user profiles stored in the profile storage 40. The connection broker 53 can be realized by a physical server.

The connection broker 53 manages a plurality of user profiles, by using the profile storage 40 which stores a plurality of user profiles that correspond to respective users. In addition, the connection broker 53 has a function (roaming function) of enabling a user to use the same user environment even when the user performs a logon operation by any fat client terminal 11.

The connection broker 53 retrieves a user account from the domain controller 54, registers the retrieved user account and the user profile which corresponds to the user account on the user management database file, and manages the user account and the user profile by the user management database file. The actual user profile may be created in advance. When there is no file, the agent creates a new file at first logon.

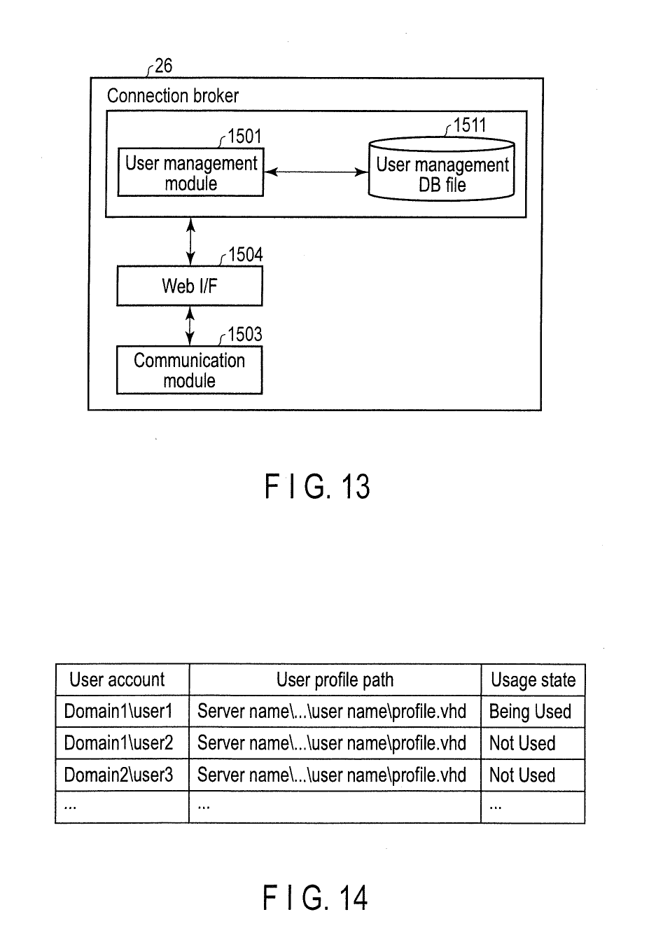

FIG. 13 is a block diagram illustrating a structure of the connection broker 53.

The connection broker 53 includes a user management module 1501, a communication module 1503, and a web interface (web I/F) 1504.

The user management module 1501 manages the user account and information of the place of storing the user profile and usage state, by using a user management database file (user management DB file) 1511.

FIG. 14 is a diagram illustrating information which is stored in the user management DB file 1511. As illustrated in FIG. 14, the user management DB file 1511 includes items “user account”, “user profile path”, and “usage state”.

The item “user account” registers user accounts which are assigned to respective users who use the terminals. The item “user profile path” registers places of storing user profiles for the user accounts, explained later. The item “usage state” registers usage states of the user profiles.

Each fat client terminal 11 accesses the user management module 1501 through the communication module 1503 and the web I/F 1504.

<Fat Client Terminal>

The fat client terminal 11 will be explained hereinafter.

The structure of the fat client terminal 11 is illustrated in FIG. 2.

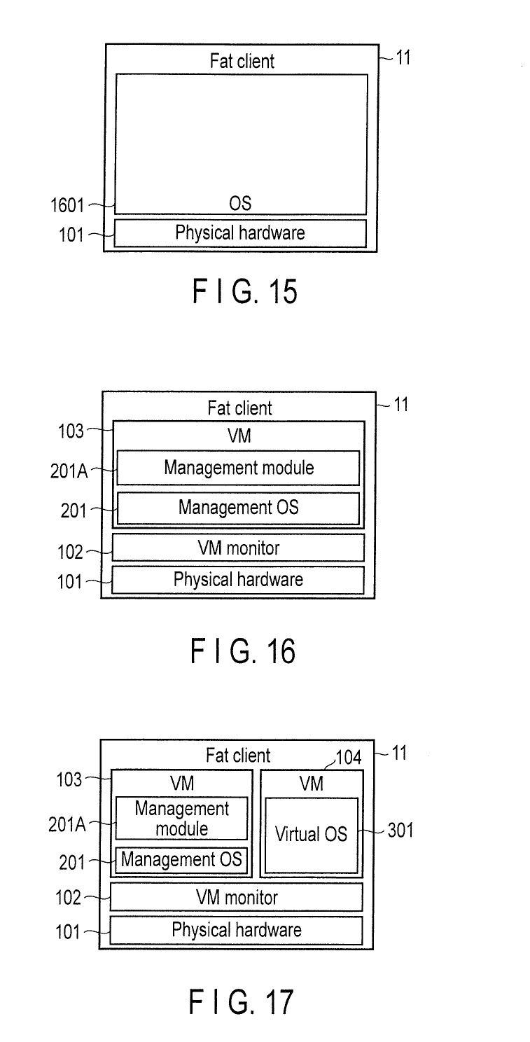

FIG. 15 is a diagram illustrating an initial state of the fat client terminal 11. As illustrated in FIG. 15, only the physical hardware and the operating system 1601 are installed in the fat client terminal 11 in the initial state.

FIG. 16 is a diagram illustrating a state in which installation is performed by executing an installer. When installation is performed, the fat client terminal 11 is changed to a state in which the virtual machine monitor 102, the management OS 201, and the virtual machine management module 201A are installed.

FIG. 17 is a diagram illustrating a state after virtual image files which are created by the virtual image file creation and distribution server 20 are downloaded.

Next, a process which is performed to cause the fat client terminal to be usable will be explained hereinafter.

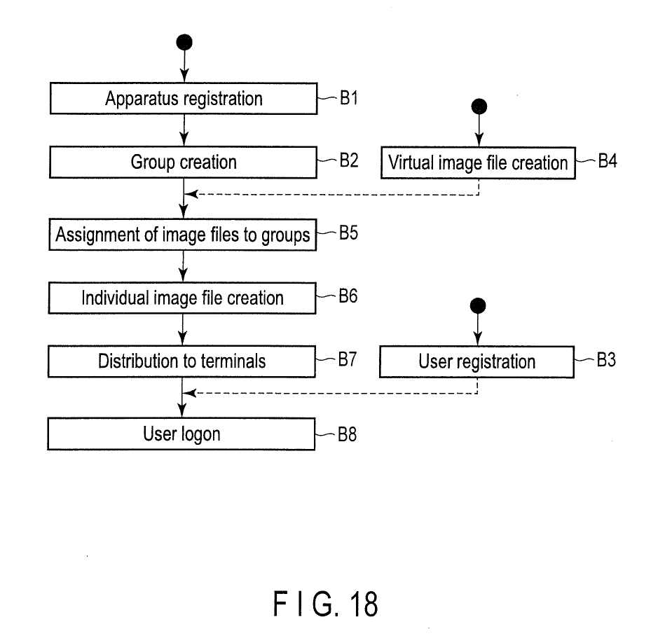

FIG. 18 is a flowchart illustrating a process which is performed to cause the fat client terminal to be usable.

<Apparatus Registration> (Block B1)

After the virtual machine 103 of the fat client terminal 11 is rebooted from the state illustrated in FIG. 16, the virtual machine management module 201A transmits the type name and the serial ID to the management server 51.

The management server 51 registers the received type name and serial ID on the client management DB file, and assigns the apparatus ID to the fat client terminal 11.

The manager accesses a webpage, which is provided by the management server 51, by the manager terminal 12, and sets a computer name which is used by the registered apparatus. In the example illustrated in FIG. 6, the computer name “Computer1” is set for the apparatus ID “M1”, the computer name “Computer2” is set for the apparatus ID “M2”, and the computer name “Computer3” is set for the apparatus ID “M3”.

<Group Creation> (Block B2)

The manager accesses a webpage which is provided by the management server 51 from the manager terminal 12, designates a group name, and registers the group on the group management DB file 713. FIG. 7 illustrates an example in which two groups, “Group1” and “Group2” are registered. The management server 51 issues a unique group ID, and registers the group ID in the group management DB file. The work until this Block may be performed before registration of the apparatus (Block B1).

Next, the apparatuses which have been registered at Block B1 are assigned to the groups, and registered in the client management DB file. This is performed by accessing the web page provided by the management server 51 from the manager terminal 12 operated by the manager. In the example of the client management DB file 711 illustrated in FIG. 6, the apparatus IDs “M1” and “M3” are registered for the group ID “G1”, and the apparatus ID “M2” is registered for the group ID “G2”.

<Creation of Virtual Image File> (Block B4)

The virtual image files are managed by a difference disk method. At this stage, a difference image file of a reset type, which is obtained by deleting specific information, and previous files are created. In the example illustrated in FIG. 12, virtual image files I1, I2, I3, I4, and I7 have been created. Then, the virtual image files are managed by the virtual image file management DB file 714 illustrated in FIG. 8.

<Assignment of Image Files to Groups> (Block B5)

After registration of the apparatuses for the groups and creation of virtual image files are finished, virtual image files can be assigned to the groups. The manager accesses the webpage provided by the management server from the manager terminal 12, and assigns virtual image files to the groups on the webpage.

In the example of the group management DB file 713 illustrated in FIG. 7, the virtual image file I4 is assigned to the group “G1”, and the virtual image file I7 is assigned to the group G2. The same virtual image file may be assigned to a plurality of groups.

<Creation of Individual Image Files> (Block B6)

When assignment of image files to groups is finished, the management server 51 issues a request to create individual image files to the virtual image file creation and distribution server.

<Distribution to Terminals> (Block B7)

When creation of individual image files is finished, the client virtualization terminals can download virtual image files.

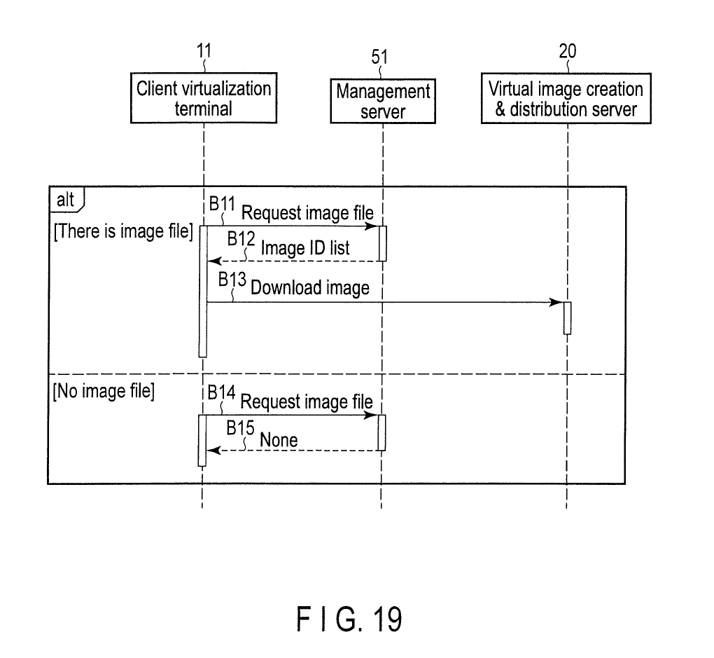

As illustrated in FIG. 19, each fat client terminal 11 queries the management server 51 as to whether there is any new virtual image file or not. The fat client terminal 11 makes this inquiry when the fat client terminal 11 is started up, and periodically after startup (Block B11, Block B14).

When there is a new image file, the management server 51 returns a list of virtual image files to the fat client terminal 11. In the case of the client M1, a list including image files I1, I3, I4, and I5 is returned. In the case of the fat client terminal M1, the list including the virtual image files I1, I3, I4, and I5 is returned. When the list includes an image file ID which is not included in the fat client terminal M1, the fat client terminal M1 requests the virtual image file creation and distribution server 20 to distribute the virtual image file (Block B13). The virtual image file creation and distribution server 20 distributes the virtual image file to the fat client terminal M1, in response to the request.

When the server does not include the required image file, the management server 51 transmits a response to the fat client terminal M1 that the server does not include the required image file (Block B15).

The virtual machine management module 201A or the fat client agent 302A downloads the virtual image file.

When reboot or shutdown is performed after download of the image file is finished, the virtual machine management module 201A creates a difference disk 36 of the downloaded image file 35 (FIG. 2).

Then, the virtual machine is rebooted by using the difference disk 36. The agent 302A performs installation of the driver and activation.

Thereafter, the agent 302A performs shutdown, after reporting to the management server 51 and the virtual machine management module 201A that update is finished. The management server 51A deletes the computer name which was used by the fat client terminal 11 the last time from the Active Directory.

When the virtual machine management module 201A detects shutdown, the virtual machine management module 201A sets the difference disk 36 as not writable. When the virtual machine is started next time, the virtual machine management module 201A creates another difference disk 37, and starts the virtual machine by using the difference disk 37. The difference disk 37 is created again each time the virtual machine is started up.

<User Registration> (Block B3)

The connection broker 53 retrieves the user account from the domain controller 54, and manages the user account in the user management DB file 1511 illustrated in FIG. 14.

The actual user profile may be created in advance. When there are no files, the agent creates a new file at first logon.

<User Logon> (Block B8)

Next, processing which is performed in logon is explained hereinafter with reference to a flowchart.

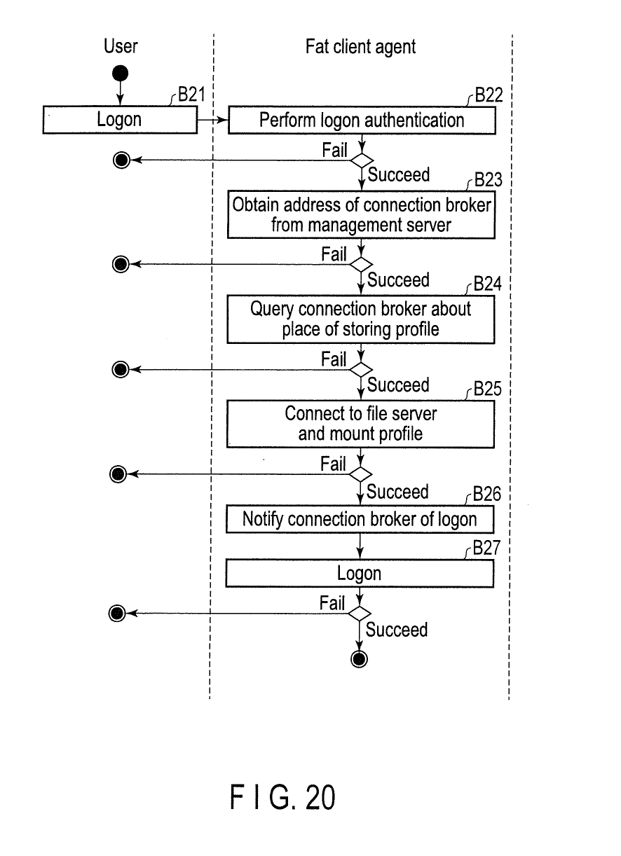

FIG. 20 is a flowchart illustrating processing which is performed in logon.

A user inputs the user account and the password, and attempts logon (Block B21). The fat client agent 302A performs logon authentication by using the inputted user account and password (Block B22). When the user is authenticated, the fat client agent 302A obtains an address of the connection broker 53 from the management server 51 (Block B23). When the address is obtained, the fat client agent queries the connection broker 53 regarding the place which stores a difference disk that stores a profile of the authenticated user account (Block B24).

When the storing place is returned in response to the inquiry about the place of storing the difference disk, the fat client agent 302A connects to the profile storage 40, and mounts the difference disk which stores the user profile (Block B25). When the mount succeeds, the fat client agent notifies the connection broker 53 of logon (Block B26). Then, logon is performed for the operating system (Block B27). When logon succeeds, the user uses the virtual machine like an ordinary personal computer (PC).

Next, creation of the virtual image file at Block B4 will be explained in more detail.

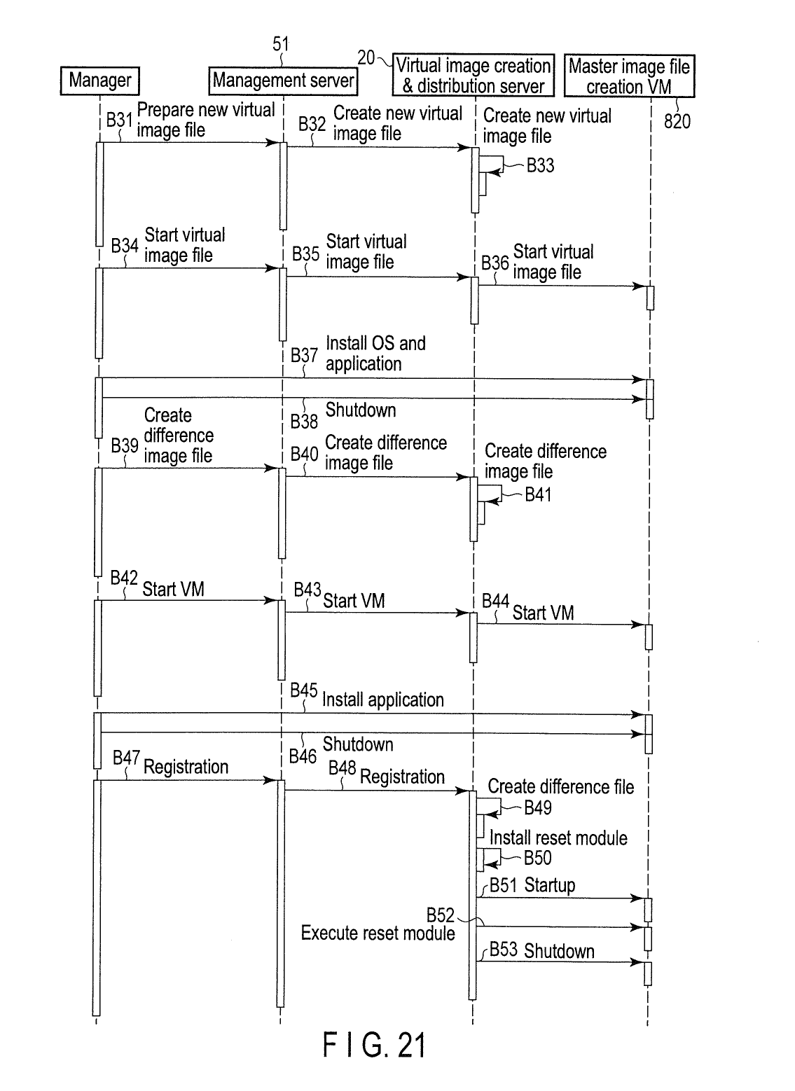

FIG. 21 is a flowchart for explaining the process from creation of the master image file to creation of the reset image file. An example of creating a master image file for group ID “G1” illustrated in FIG. 7 will be explained hereinafter.

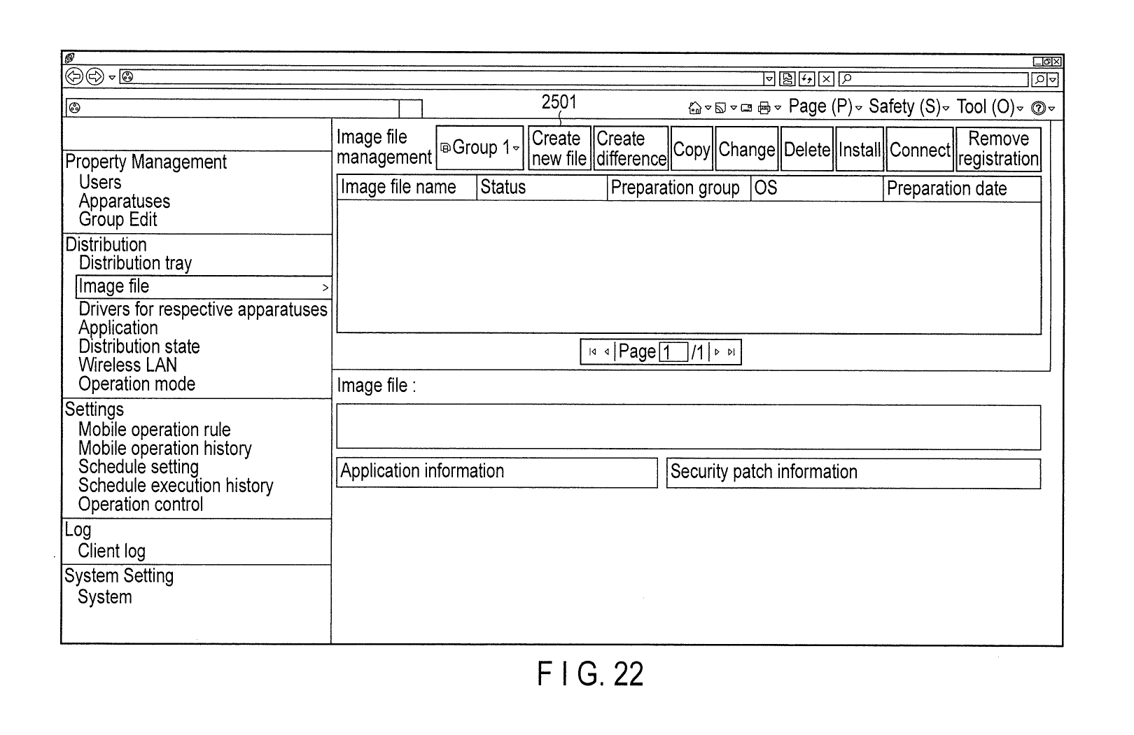

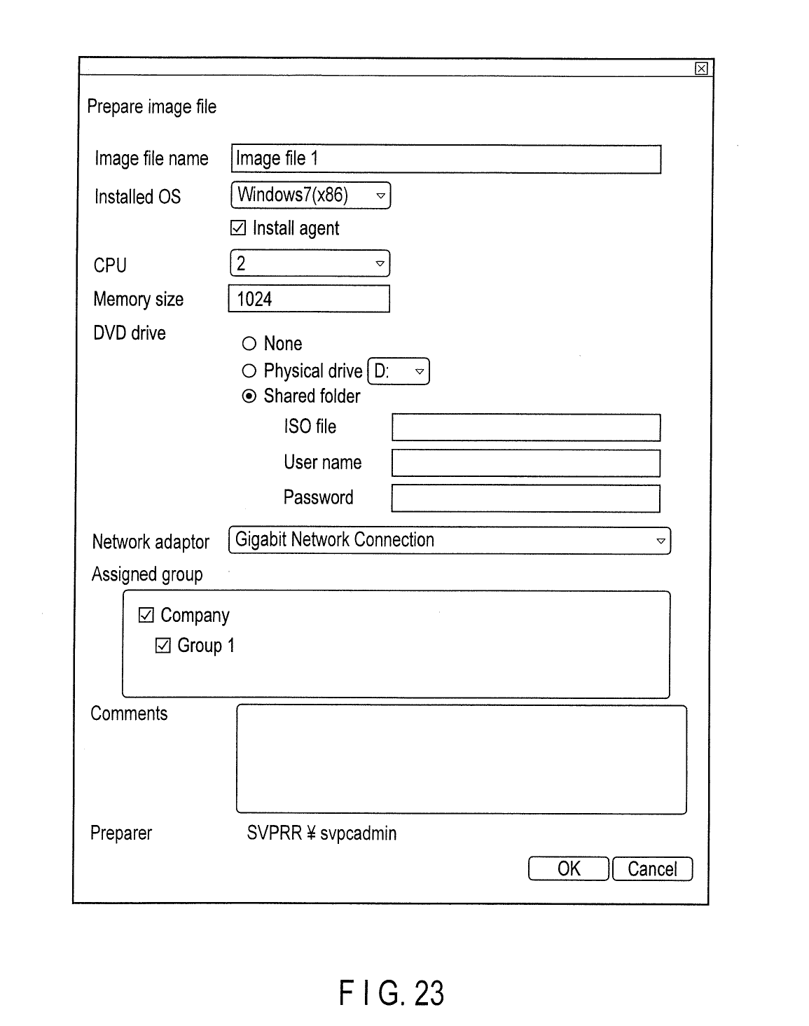

First, the manager accesses the web interface 705 of the management server 51 by using the web browser of the manager terminal 12. The web browser obtains HTML data from the web interface 705, and displays a webpage for setting the system. The manager operates an image in the webpage, and causes the web browser to display an image file creation picture as illustrated in FIG. 22. When the manager operates a new creation button 2501 in the image file setting picture of FIG. 22, the web browser displays a new image file creation picture as illustrated in FIG. 23.

The new image file creation picture is provided with items “image file name”, “installed OS”, “CPU”, “memory size”, “DVD drive”, “network adaptor”, “assigned group”, and “comments”. The item “image file name” is provided to set a name of the created virtual image file. The item “installed OS” is provided to set an operating system which is installed in the virtual image file. In the example of FIG. 23, Windows 7(x86) is set as the installed OS. In addition, a check box to set whether the agent is installed or not is provided. The item “CPU” is provided to set the number of cores of the CPU. The item “memory size” is provided to set the size (MB) of the memory used by the virtual machine when the virtual machine is executed. The item “DVD drive” is provided to set the DVD drive. The item “DVD drive” includes choices “None”, “Physical drive (select drive letter)”, and “Shared folder”. When the manager selects the choice “Shared folder”, the manager inputs the path of the ISO file, and the user name and the password to access the ISO file. The item “network adaptor” is provided to set a virtual network adaptor in the virtual machine. The item “assigned group” indicates a group which the created image file can belong to.

After setting is performed, when the manager pushes an OK button, the setting is transmitted to the management server 51, and new creation of a virtual image file is requested of the management server (Block B31). When the management server 51 is requested to create a new virtual image file, the management server 51 transmits the received setting to the virtual image file creation and distribution server 20, and requests the virtual image file creation and distribution server 20 to create a new virtual image file (Block B32). The virtual image file creation and distribution server 20 creates a new virtual image file based on the setting (Block B33).

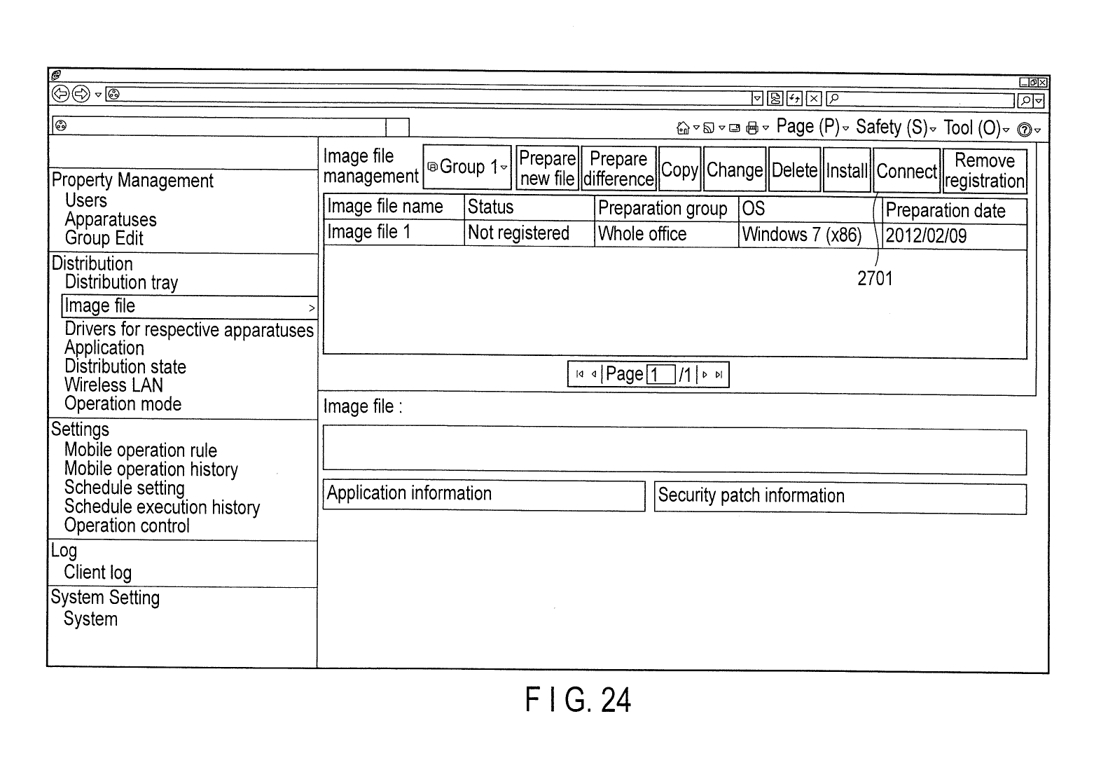

When the virtual image file creation and distribution server 20 creates a new image file, the web browser displays an image file creation picture as illustrated in FIG. 24. The image file creation picture illustrated in FIG. 24 includes a newly created image file 1. Although the status of the image file 1 is displayed as “not registered” in the picture, the image file corresponds to the master image file in FIG. 9.

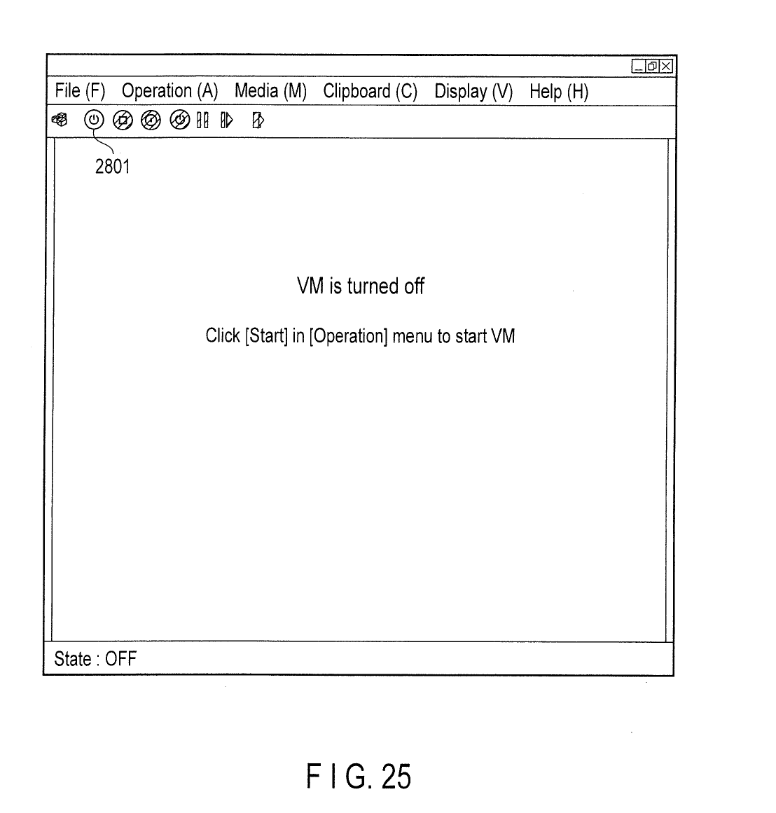

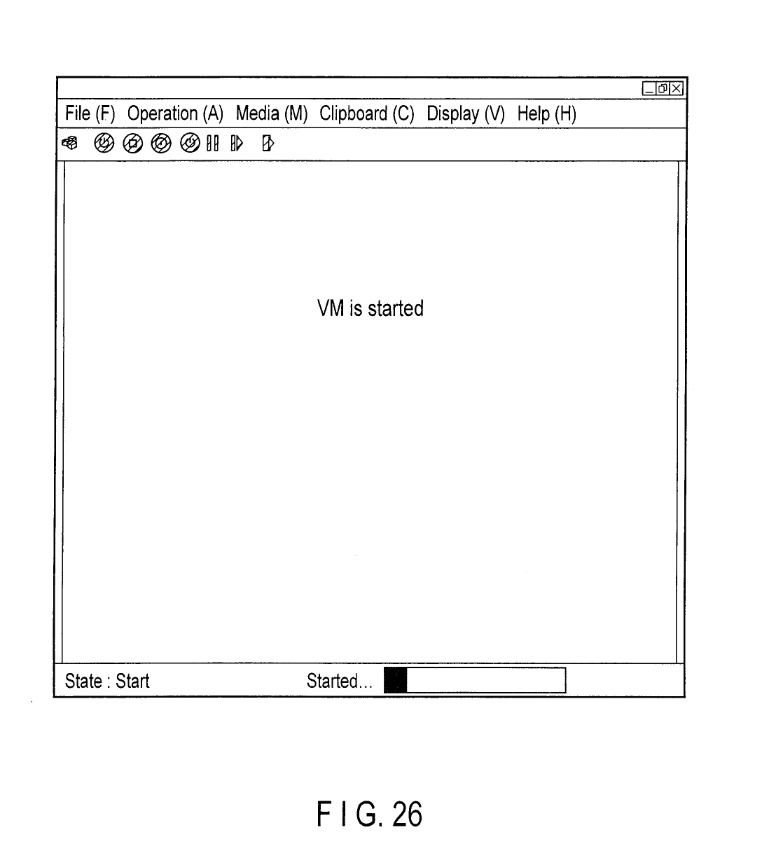

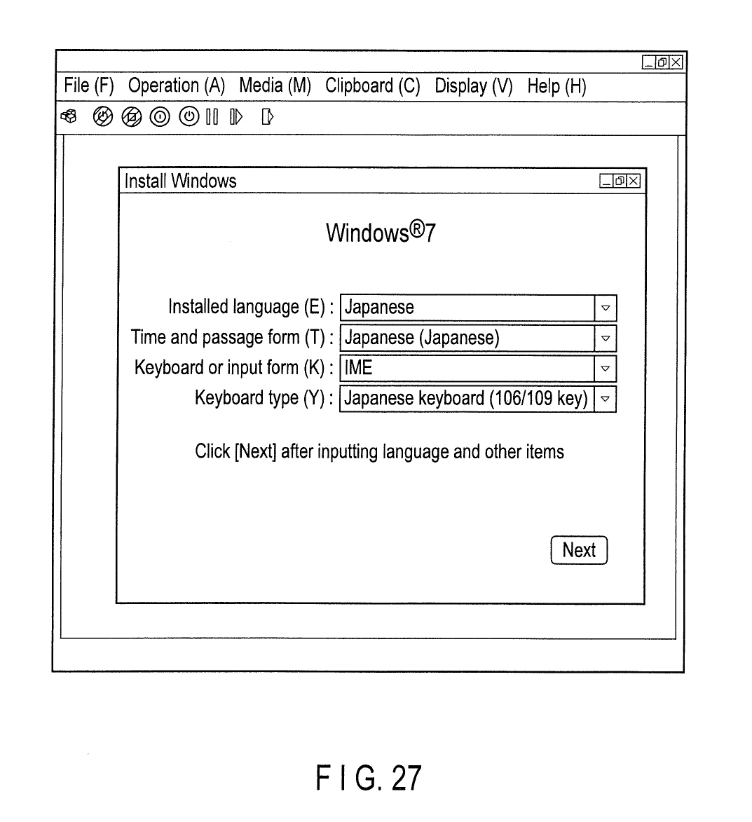

When the manager operates a connection button 2701 in FIG. 24, a picture illustrated in FIG. 25 is displayed. When the manager pushes a power button 2801, the management server 51 is requested to connect the created virtual image file (Block B34). While the virtual machine is being started up, a picture illustrated in FIG. 26 is displayed. In response to the request, the management server 51 requests the virtual image file creation and distribution server 20 to start the virtual image file (Block B35). The virtual image file creation and distribution server 20 starts a master image file creation virtual machine 820 by using the virtual image file (Block B36).

The manager starts an operating system from the DVD which is set in the image file creation picture, and installs the operating system in the master image file creation virtual machine 820 (Block B37, FIG. 21). When there is any application which is used by a plurality of groups, the application may be installed at this Block. When installation is finished, the manager shuts down the master image file creation virtual machine 820 (Block B38).

After the manager operates a difference creation button and selects the image file 1, the manager requests the management server 51 to create a difference image file (virtual image file I3) (Block B39). In response to the request, the management server 51 requests the virtual image file creation and distribution server 20 to create a difference image file (virtual image file I3) for the image file 1 (Block B40). In response to the request, the virtual image file creation and distribution server 20 creates a difference image file (virtual image file I3) for the image I1 (Block B41).

The manager requests the management server 51 to start the virtual machine using the virtual image file I3 (Block B42). The management server 51 requests the virtual image file creation and distribution server 20 to start the virtual machine using the virtual image file I3 (Block B43). The virtual image file creation and distribution server 20 starts the virtual machine by using the virtual image file I3 (Block B44). The manager installs the application which is used in Group 1 (Block B45). After installation, the manager shuts down the virtual machine (Block B46).

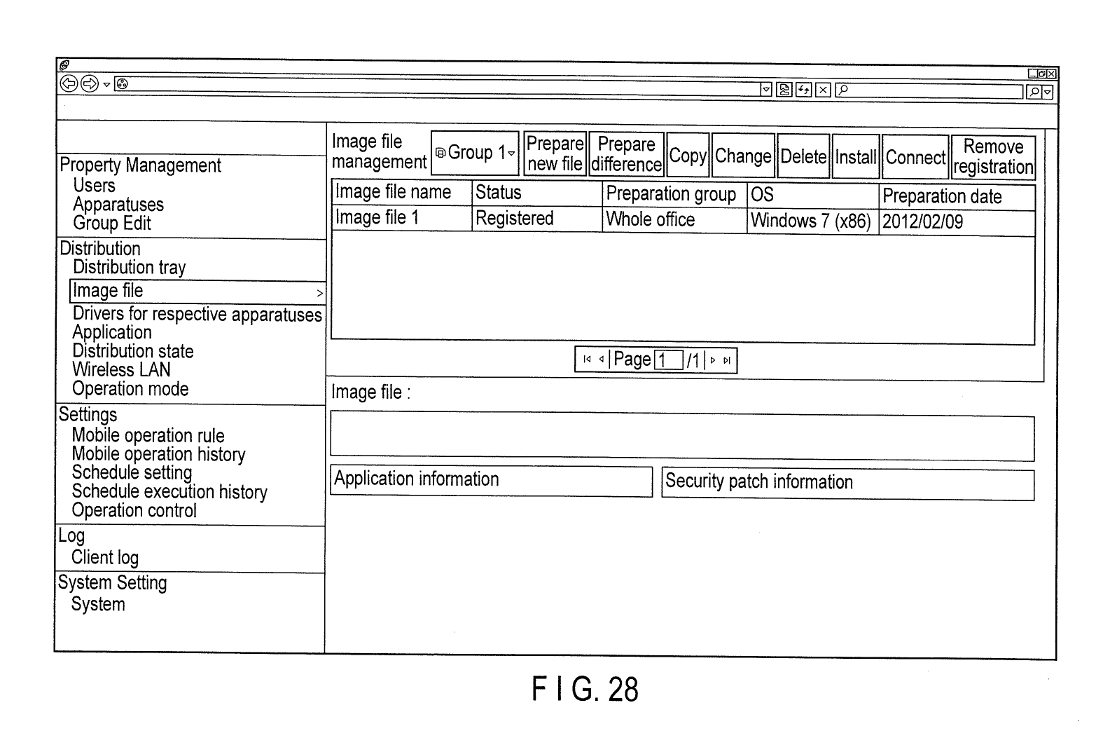

When the manager operates a registration button (Block B47), the virtual image file management module 704 of the management server 51 registers the virtual image file I3 on the virtual image file management DB file 714 (Block B48). As illustrated in FIG. 28, the status of the image file 1 is changed from “not registered” to “registered”.

Then, the management module 704 requests the virtual image file creation and distribution server 20 to create a difference disk. The virtual image file creation and distribution server 20 creates a virtual image file I4 as a difference disk for the virtual image file I3 (Block B49).

The virtual image file creation and distribution server 20 installs a reset module to reset specific information for the virtual image file I4 (Block B50). The term “reset module” indicates a parameter file to perform reset of the peculiar information, and a program which is executed when initialization is performed after the reset. Then, the virtual image file creation and distribution server 20 starts the virtual machine by using the virtual image file I4 (Block B51). After startup, the virtual image file creation and distribution server 20 executes the reset module, and performs reset of the peculiar information (Block B52). After reset, the virtual image file creation and distribution server 20 shuts down the virtual machine (Block B53).

Thereby, the created image file I4 can be assigned to the groups. By the same process, the virtual image file I7 can be assigned to the groups.

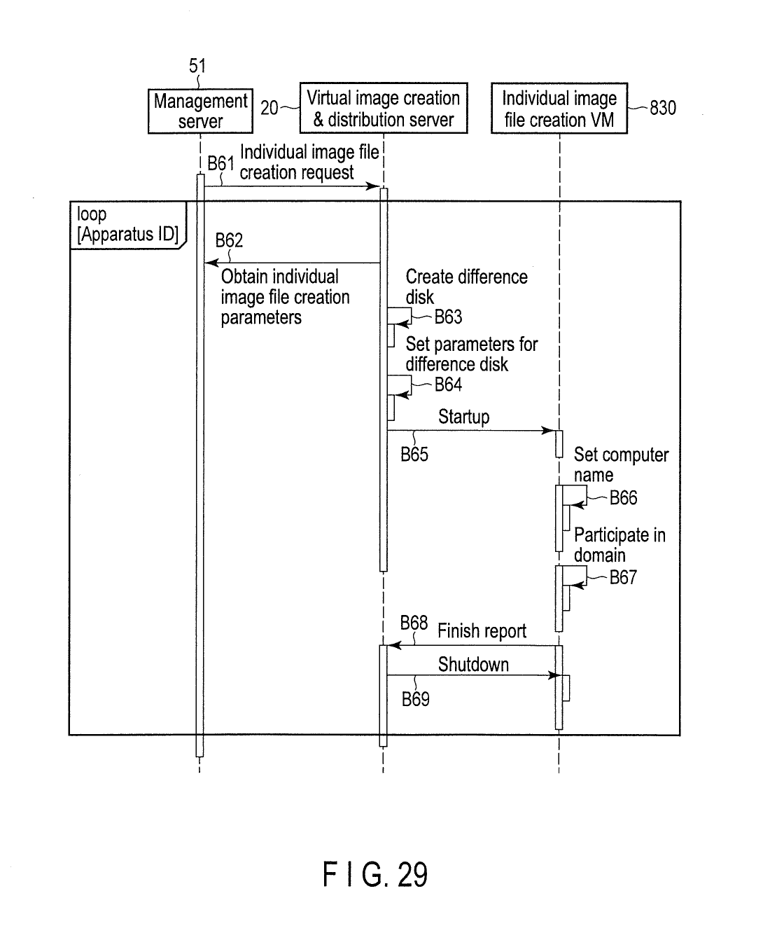

FIG. 29 is a diagram illustrating a process of creating the individual image file at Block B6.

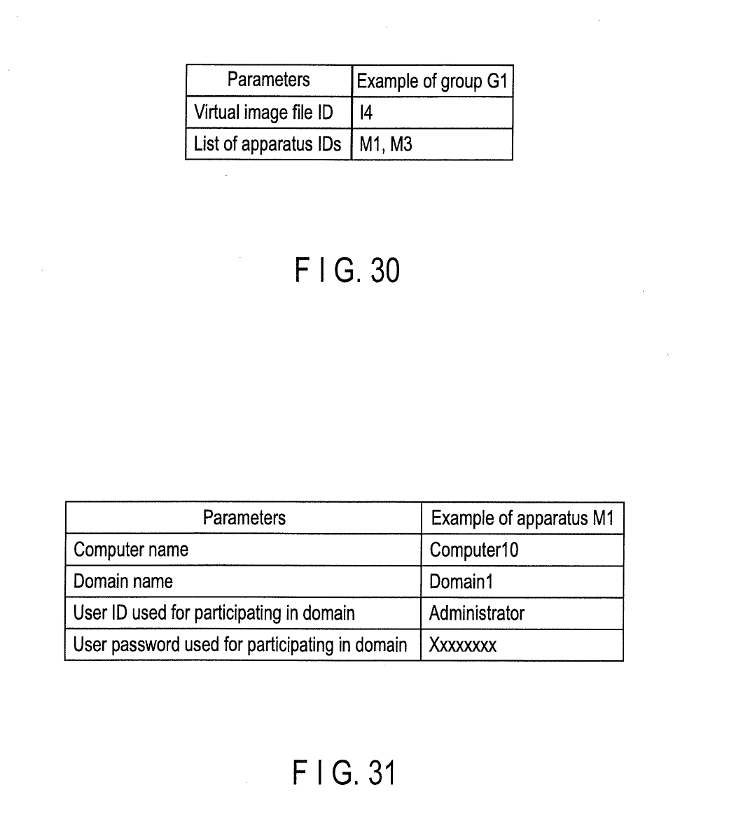

The management server 51 transmits an individual image file creation request command for the fat client terminal M1, and thereby requests the virtual image file creation and distribution server 20 to create difference disk I5 from the virtual image file I4 (Block B61). FIG. 30 illustrates parameters which are included in the individual image file creation request command. As illustrated in FIG. 30, the individual image file creation request command includes a virtual image file ID and a list of apparatus IDs. In the example illustrated in FIG. 30, “I4” is registered as the virtual image file ID, and “M1” and “M3” are registered as the list of the apparatus IDs.

The virtual image file creation and distribution server 20 obtains individual image file creation parameters from the management server 51 (Block B62). FIG. 31 illustrates an example of the individual image file creation parameters. The individual image file creation parameters include computer name, domain name, user ID for participating domain, and user password used for participating domain. In the example illustrated in FIG. 31, “Computer 10” is registered as the computer name, “Domain1” is registered as the domain name, “Administrator” is registered as the user ID used for participating in the domain, and “Xxxxxxxx” is registered as the user password used for participating in the domain.

The virtual image file creation and distribution server 20 creates difference disk I5 from the virtual image file I4, based on the parameters included in the individual image creation request command (Block B63). The virtual image file creation and distribution server 20 sets the computer name, the domain name, the user ID used for participating in the domain, and the user password used for participating in the domain for the difference disk I5, based on the individual image file creation parameters (Block B64).

The virtual image file creation and distribution server 20 starts a virtual machine 830 by using the virtual image file I5 (Block B65). After startup, the individual image file creation virtual machine 830 executes initialization after reset. Initialization after the reset is automatically executed in startup which is performed after reset of the specific information by the reset module. By the initialization after reset, the computer name of the individual image file creation virtual machine 830 is changed to “Computer10” (Block B66). Then, the individual image file creation virtual machine 830 performs domain participation (Block B67). When the virtual machine 830 participates in the domain, the individual image file creation virtual machine 830 reports to the virtual image file creation and distribution server 20 that the virtual machine has participated in the domain (Block B68). Then, the virtual image file creation and distribution server 20 shuts down the individual image file creation virtual machine 830 (Block B69). Creation of the individual image file of the apparatus M1 is finished as described above. Then, the system starts processing for the next apparatus.

Creation of the individual image file is as described above. According to the present embodiment, the virtual image file creation and distribution server 20 sets the domain name of the domain, and the user ID and the password for participating in the domain when the individual image file is created, and thereby it is unnecessary to set the domain name of the domain or the user ID and the password for participating in the domain, when the virtual machine is executed by using the virtual image file after the virtual image file is distributed. Therefore, it is possible to reduce the time which is required until the fat client terminal 11 executes the virtual machine by using the distributed virtual image file after the virtual image file is distributed to the fat client terminal 11.

In addition, the machine name of the virtual machine which is executed by using the virtual image file is changed each time the individual image file is updated, and thereby it is possible to participate in the domain even when a virtual machine which uses the virtual image file which is not updated is executed, since the virtual machines have different machine names.

(Modification)

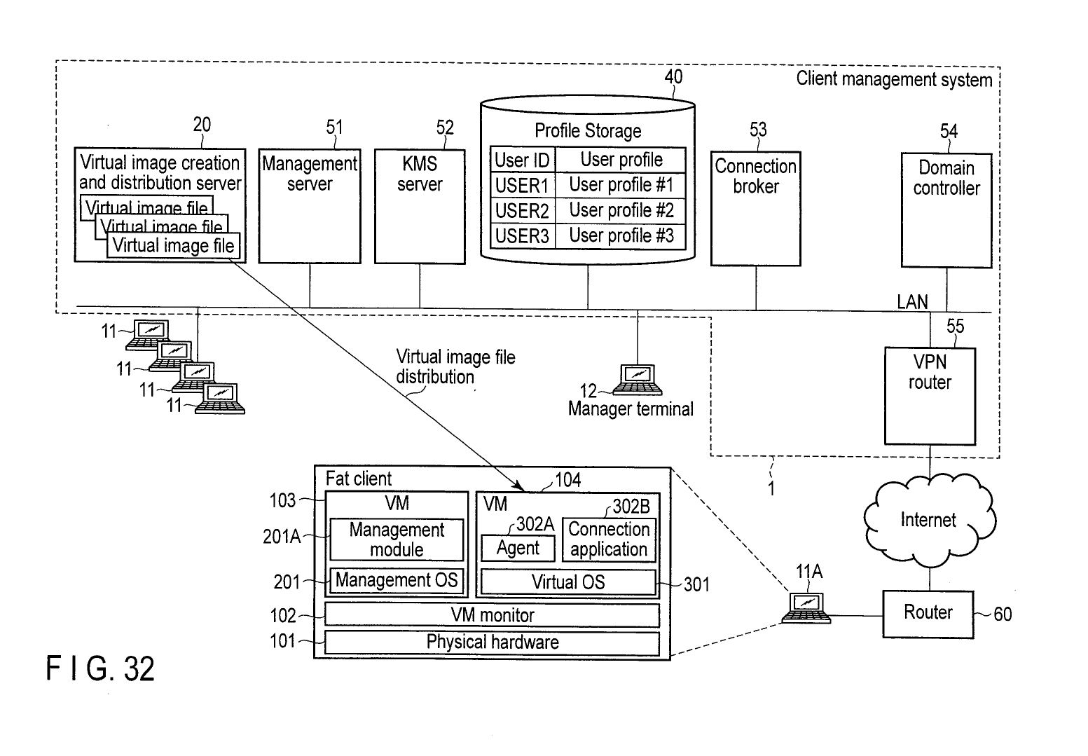

FIG. 32 is a block diagram illustrating a structure of a client management system 1 according to a modification.

As illustrated in FIG. 32, the client management system 1 comprises a management server 51, a KMS server 52, a connection broker 53, a domain controller 54, a virtual image file creation and distribution server 20, a connection broker 53, a profile storage 40, and a VPN router 55, and the like.

A plurality of fat client terminals 11 are also connected to the above network, for example, a LAN. The VPN (Virtual Private Network) router 55 is connected to the Internet. A fat client terminal 11A which is provided outside the office can access apparatuses in the client management system through a router 60, the Internet, and the VPN router 55.

A connection application 302B is installed in a virtual machine 104.

The KMS server 52 is a server which performs authentication instead of the server of Microsoft (Registered Trademark) when Windows (Registered Trademark) is activated.

The VPN router 55 is a router configured to construct a virtual private network using the Internet, by using a protocol such as IPsec, PPTP, and TLS. By using IPsec or PPTP, it is possible to perform communication of encoded data by encapsulation and tunneling between a plurality of positions through the Internet, while the communication data is protected against falsification and wiretapping.

In the prior art, it is impossible to update the image file of the fat client terminal 11A which is used by connecting to the intra-office system 1 in a remote manner, due to the following two reasons.

Domain participation is performed by the client virtualization terminal.

User operation is required until activation is finished.

The measure against the former is shown by the above embodiment. The measure against the latter will be explained hereinafter.

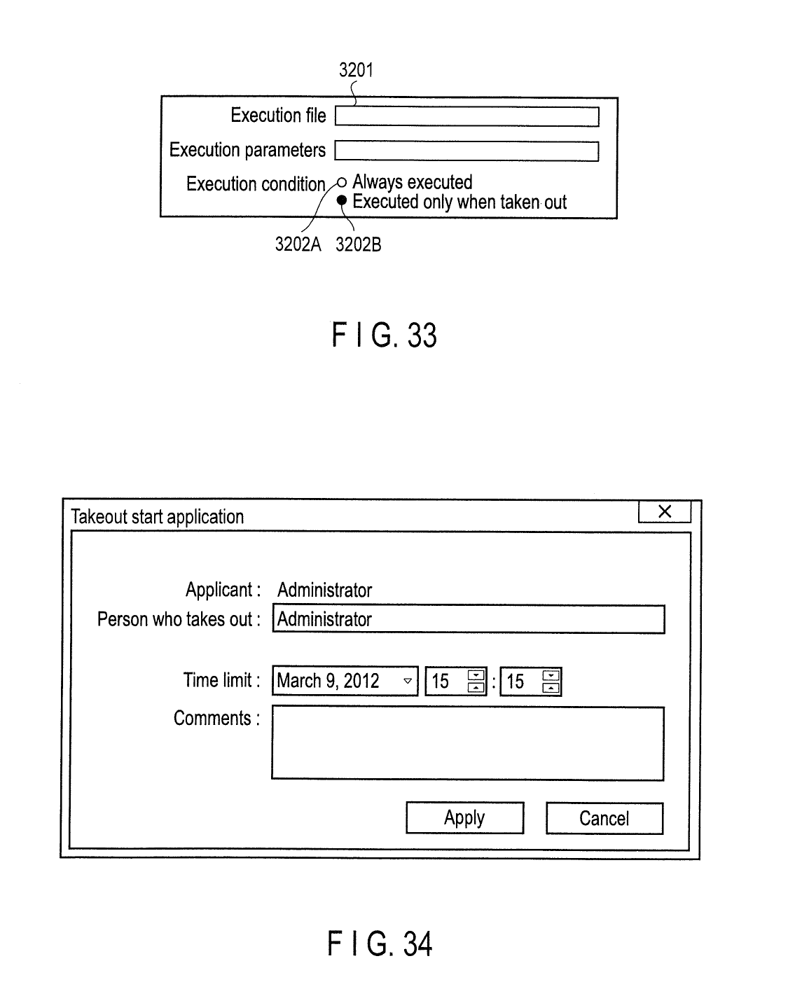

The management server 51 creates a setting picture (webpage) displayed on the manager terminal 12, which is illustrated in FIG. 33, such that the manager can register the application which is executed before logon. A full path of the application in the virtual machine is set in an execution file designation space 3201. In addition, one of radio buttons 3202A and 3202B is selected, to select one of execution conditions “always executed” and “executed only when taken out”.

When the execution condition is “always executed” (select radio button 3202A), the designated application is executed whenever the terminal is started. When the execution condition is “executed only when taken out” (select radio button 3202B), the designated application is executed while the terminal is taken out. The manager registers the connection application 302B as the application which is “executed only when taken out”.

When the fat client terminal 11A is taken outside the office, the user makes a takeout application by an application picture of FIG. 34, which is displayed by the fat client agent. The application picture is provided with columns for setting the person who takes out the terminal, time limit, and comments. When the user makes an application, the state is stored in the management server 51 and the fat client terminal 11A. When the user does not make an application that the user has taken the terminal back to the office by the time limit, logon by the user is rejected.

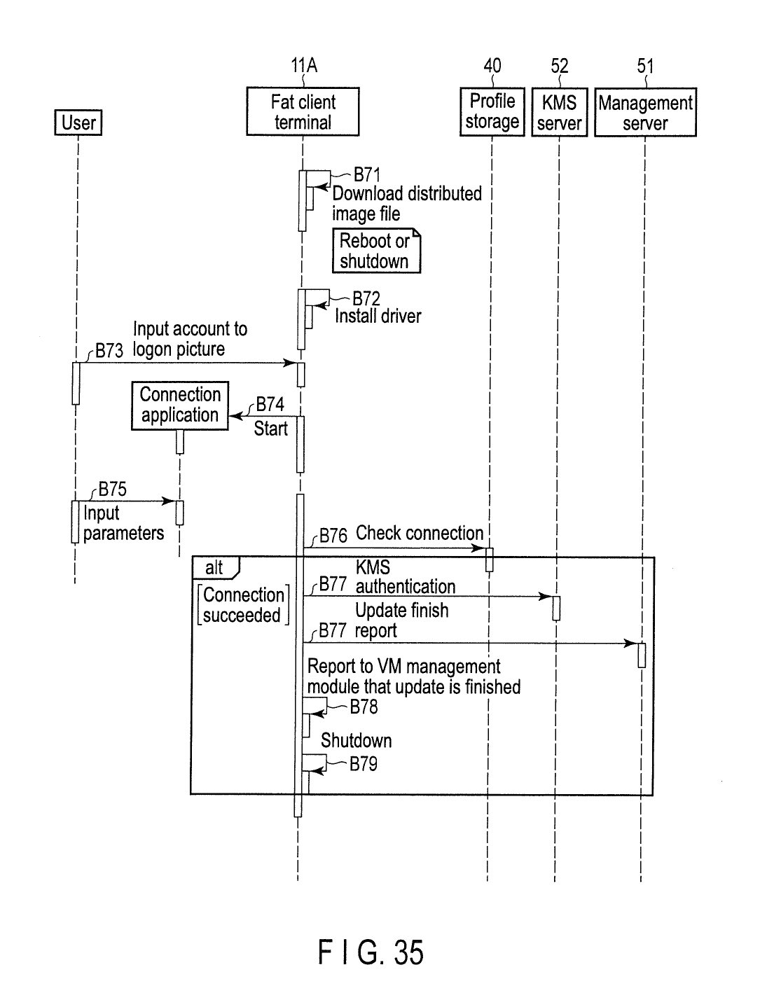

FIG. 35 is a flowchart of processing of updating the image file when the terminal is connected to the system from the outside to the inside of the office while the terminal is taken out.

In the same manner as used in the office, when reboot or shutdown is detected after download of the distributed image file by the fat client terminal 11A is finished (Block B71), the virtual machine management module 201A of the fat client terminal 11A creates a difference disk 36 of the downloaded virtual image file.

Then, the virtual machine management module 201A reboots the virtual machine by using the difference disk 36. The agent 302A installs the driver (Block B72), and displays a logon picture without activation.

When the user inputs the account (Block B73), the agent 302A starts the registered connection application 302B (Block B74). If necessary, the user performs key inputs (such as PIN) for the application 302B (Block B75).

The agent 302A determines whether remote connection to the intra-office system has succeeded or not (Block B76). The agent 302A determines whether the remote connection has succeeded or not, based on whether the terminal can connect to the profile storage 40 which stores the user profiles. When connection is established, the agent 302A causes the KMS server 52 and the operating system to perform KMS authentication (activation) of the operating system (Block B77).

After authentication, the agent 302A reports to the management server 51 and the virtual machine management module 201A that update is finished (Block B77, Block B78), and performs shutdown (Block B79). The management server 51 deletes the computer name which was previously used by the fat client terminal 11A from the Active Directory.

When the virtual machine management module 201A detects shutdown, the virtual machine management module 201A makes the difference disk 36 unchangeable. When the virtual machine is started next time, the virtual machine management module 201A creates another difference disk 37, and starts the virtual machine by using the difference disk 37. A difference disk 37 is created whenever the virtual machine is started.

The connection application 302A is installed and the agent 302A causes the KMS server 52 and the operating system to perform KMS authentication (activation) of the operating system, and thus it is unnecessary to perform user operation for activation.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus configured to create a virtual image file executing a virtual machine by a virtualization client terminal, the apparatus comprising:
a setting module configured to set, for the virtual image file, a domain name of a domain and a user ID and a password to participate in the domain, when the virtual image file is created.

2. A system for managing client terminals on a network, the system comprising:
a virtual image file creation server configured to create a virtual image file for executing a virtual machine by a virtualization client terminal, and comprising a setting module configured to set, for the virtual image file, a domain name of a domain and a user ID and a password to participate in the domain, when the virtual image file is created.

3. The system of claim 2, wherein
the virtual image file creation server is configured to create a first virtual image file for executing a first virtual machine by the virtualization client terminal, and to create a second virtual image file for updating the first virtual image file and executing a second virtual machine by the virtualization client terminal after the first virtual image file is created,
wherein the system further comprises a management server configured to notify the virtual image file creation server of a first computer name and a second computer name, the first computer name being set for the first virtual machine and the second computer name being set for the second virtual machine and being different from the first computer name.

4. The system of claim 3, further comprising:
an activation server configured to activate an operating system in the virtual machine;
wherein the virtual image file creation server is configured to install a connection application program and an agent program in the second virtual machine, the connection application program being executed when remote connection to the client management system is performed; and
the agent program is configured to determine whether the remote connection is performed, and to cause the activation server and the operating system to perform activation of the operating system when the agent program determines that the remote connection is performed.

5. A virtual image file creation method comprising:
setting, for a virtual image file to execute a virtual machine by a virtualization client terminal, a domain name of a domain and a user ID and a password to participate in the domain, when the virtual image file is created.

6. The method of claim 5, further comprising:
creating a first virtual image file for executing a first virtual machine by the virtualization client terminal;
creating a second virtual image file for updating the first virtual image file and for executing a second virtual machine by the virtualization client terminal; and
setting a first computer name and a second computer name, the first computer name being set for the first virtual machine, the second computer name being set for the second virtual machine and being different from the first computer name.

7. The method of claim 6, further comprising:
installing a connection application program and an agent program in the second virtual machine, the connection application program being executed when remote connection to the client management system is performed,
determining, by the agent program, whether the remote connection is performed, and
causing, by the agent program, the activation server and the operating system to perform activation of the operating system when the agent program determines that the remote connection is performed.
